(19) United States
(12) Patent Application Publication
(10) Pub. No.: US 2002/0059124 A1
(43) Pub. Date: May 16, 2002

(54) Table implemented procedures with attribute calls initiating business rules

(76) Inventors: Terrance J. Krolak, Prior Lake, MN (US); Michael Patrick Regan, Apple Valley, MN (US)

Correspondence Address: Beck & Tysver, P.L.L.C., Suite 100, 2900 Thomas Avenue South, Minneapolis, MN, 55416, US

(21) Appl. No.: 09/953,491

(22) Filed: Sep. 14, 2001

Related U.S. Application Data
(60) Provisional application No. 60/232,697, filed on Sep. 15, 2000.

(51) Int. Cl. G06F 17/60

(52) U.S. Cl. 705/35

(57) ABSTRACT

A method and system are presented for the utilization of a database entry defining procedures that include requests for attribute values. In one embodiment, the requests for attribute values are located in reviews that are called by the procedures. When an attribute value is requested, business logic is evaluated to determine the result of the attribute value.

### CROSS-REFERENCE TO A RELATED APPLICATION

This application claims the benefit of, and incorporates by reference, U.S. Provisional Application No. 60/232,697, filed Sep. 15, 2000.

TECHNICAL FIELD

The present invention relates generally to the computerization of business process definitions. More particularly, the present invention relates to the utilization of table defined procedures accessing attributes, with each attribute provoking a call to computerized business process definitions.

### BRIEF DESCRIPTION OF THE INVENTION

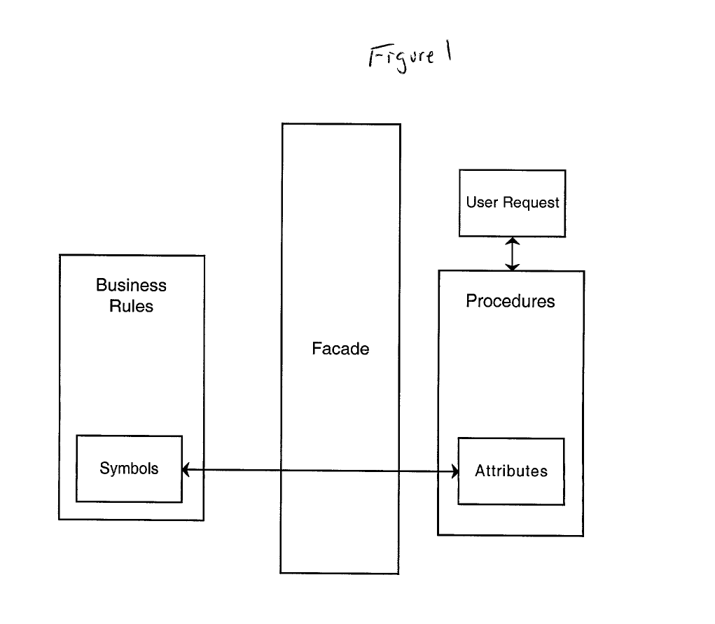

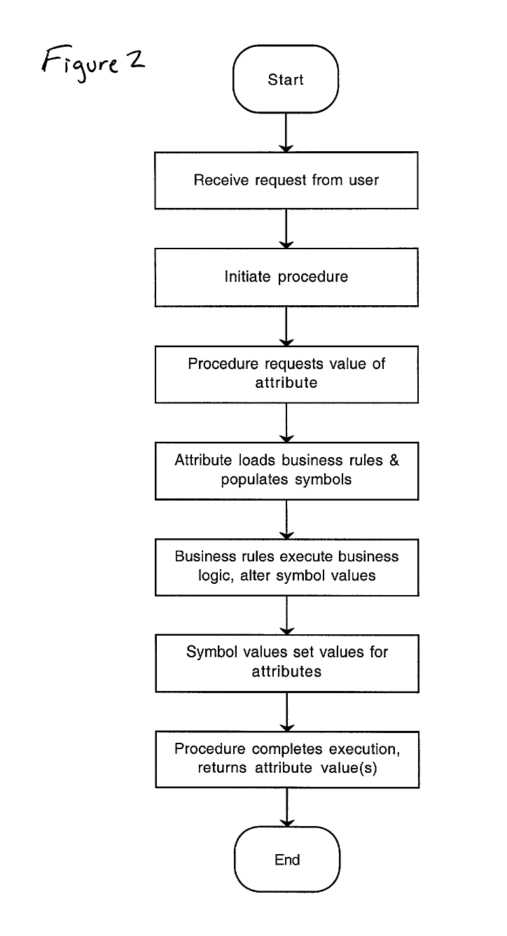

FIG. 1 is a block diagram showing computerized business rules on the left and business procedures on the right. The business rules on the left constitute the computerized embodiment of business logic. As is known in the prior art, it is useful to give business managers access to these business rules, so that the business logic embodied in those rules can be reviewed and updated directly by the business manager. The procedures on the right support the business rules, and provide the business rules with access to needed business data.

In the preferred embodiment, user interaction takes place via a request to the procedures on the right. Traditionally, these procedures are coded by programmers, and include various attributes. These attributes can contain the business data provided either by the user with the request or through access to stored sources of business data. Alternatively, these attributes can be calculated based upon the user data.

In the context of the analyzing financial products, the calculation behind these attributes can be quite complex. For instance, the user request may include loan application data. One of the attributes that is to be calculated based upon this data may be the maximum loan amount available to this applicant given the data included in the loan application. This type of calculation ideally utilizes the business rules on the left of FIG. 1. In fact, in the preferred embodiment, the mere request for a particular attribute value by a procedure will trigger the business rules on the left required to calculate the value for that attribute.

The business rules are not provided direct access to the attributes, but rather store data in symbols. Because the business rules may use various approaches to deliver the correct attribute calculation, it is sometimes necessary for the business rules to return to an earlier state. This allows the business rules to redo a portion of their calculation from an earlier point in time. To accomplish this, symbols are stored in stacks, allowing later symbol states to be popped off the stack in order to return to an earlier place in time.

The communication between the procedures and the business rules takes place through a facade. The facade is responsible for initiating the appropriate business rules when an attribute value needs to be calculated. The facade is also responsible for mapping data between the attributes used by the procedures and the symbols used by the business rules.

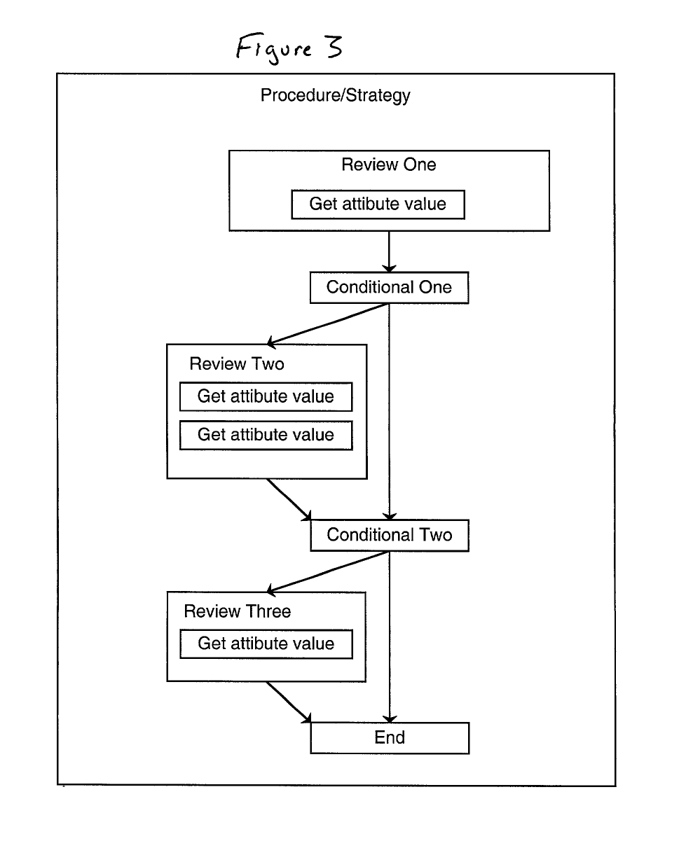

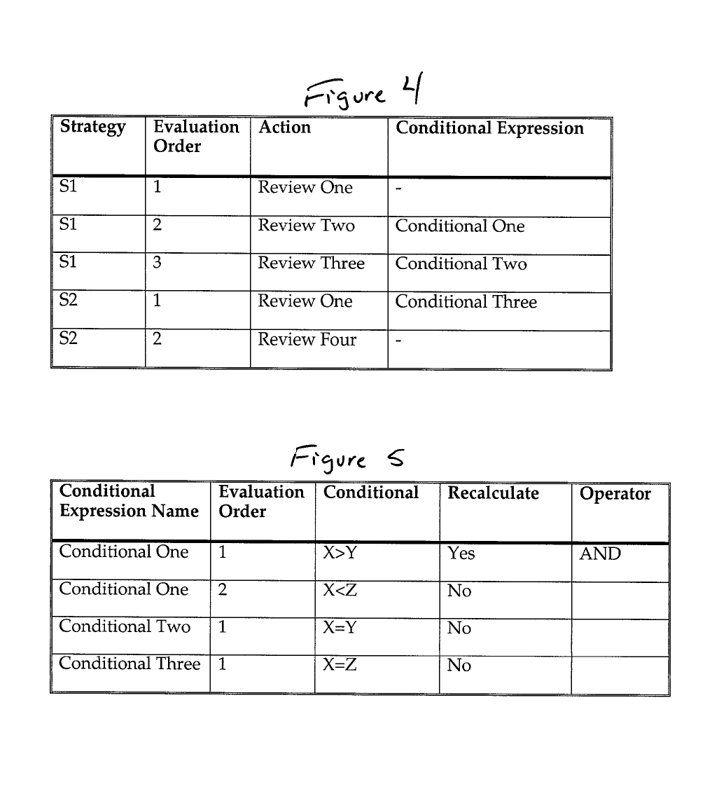

FIG. 2 contains a flow chart showing the process used by the system of FIG. 1. First, the user request is received, which initiates a procedure. The procedure requests the value of an attribute, which prompts the facade to load the appropriate business rules and to populate the symbol values. The business rules then execute, which will alter the symbol values. When the business rules have completed their execution, the facade uses the mapping between symbol values and attributes to set the values for certain attributes. Note that there does not have to be a one to one mapping between symbols and attributes, nor do all changes to symbol values get mapped back to the attributes. Finally, the procedure completes its execution using the attribute value, and will return a result to the user.

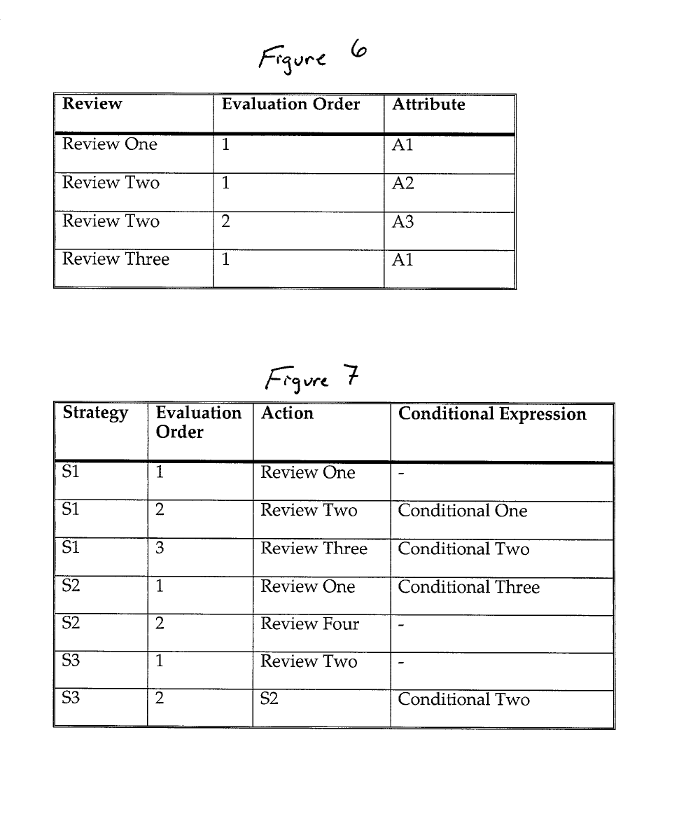

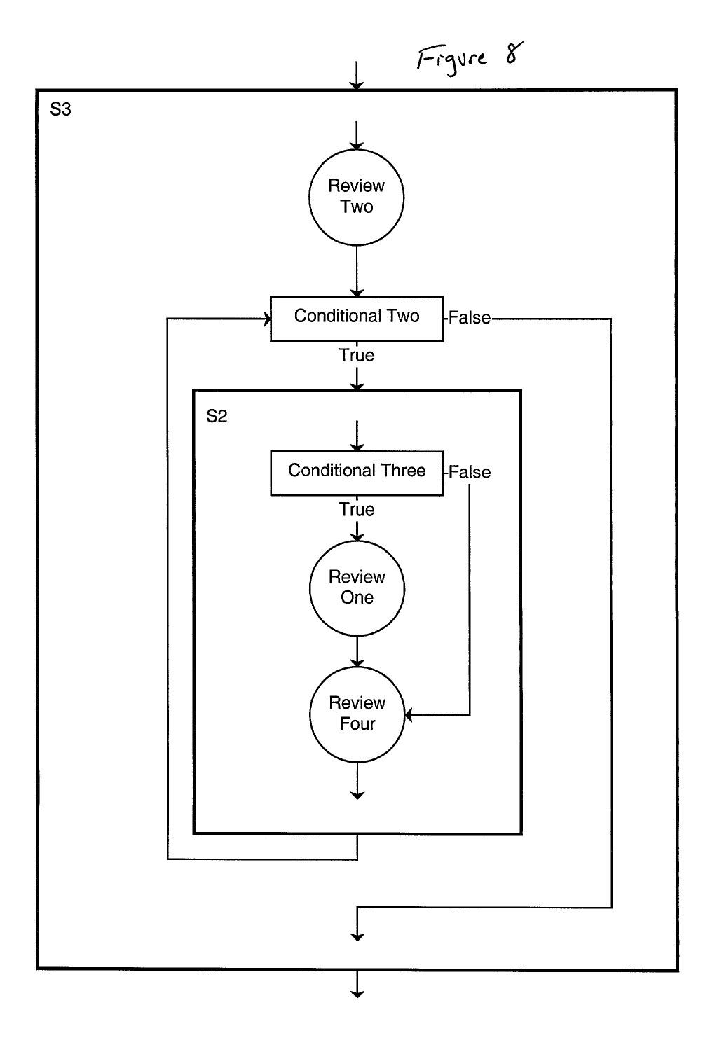

FIG. 3 shows a procedure as might be used by the present invention. In the preferred embodiment, a procedure is often referred to as a strategy. The strategy is itself comprised of sub-elements called reviews. In FIG. 3, the process flow of the procedure is shown with arrows. Review one is processed first. In this case, Review one has a single function, which is to get a single attribute value. As discussed above, retrieving an attribute value may trigger business rules to calculate the value of that attribute. After Review one is completed, a conditional expression (Conditional one) is executed. If this conditional returns a first value (such as true), the Review two is executed, otherwise Review two is skipped. Review two simply retrieves two more attribute values. Conditional two then determines whether Review three will be executed. Review three retrieves another attribute value. After this, the procedure/strategy of FIG. 3 is complete. Traditionally, this type of simple procedure was hard coded by programmers. Although simple in function, it could accomplish powerful business logic through the use of business rules triggered by accessing the appropriate attribute values.

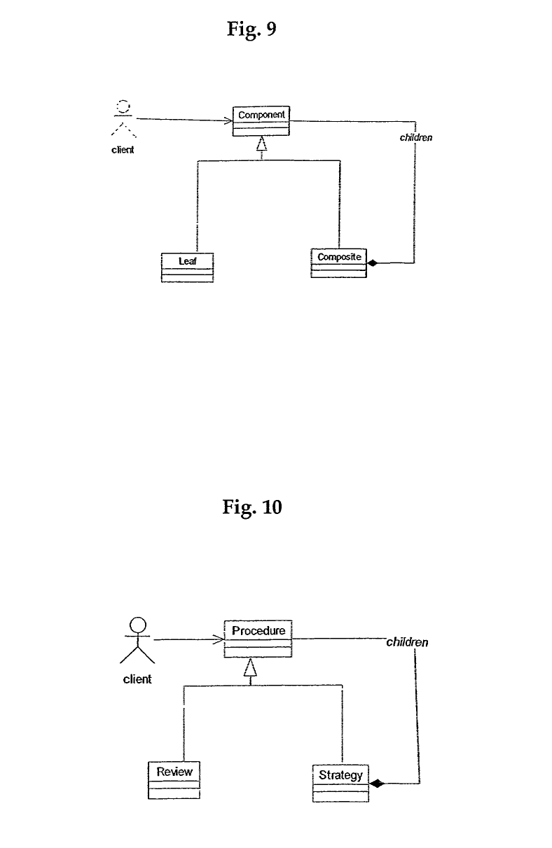

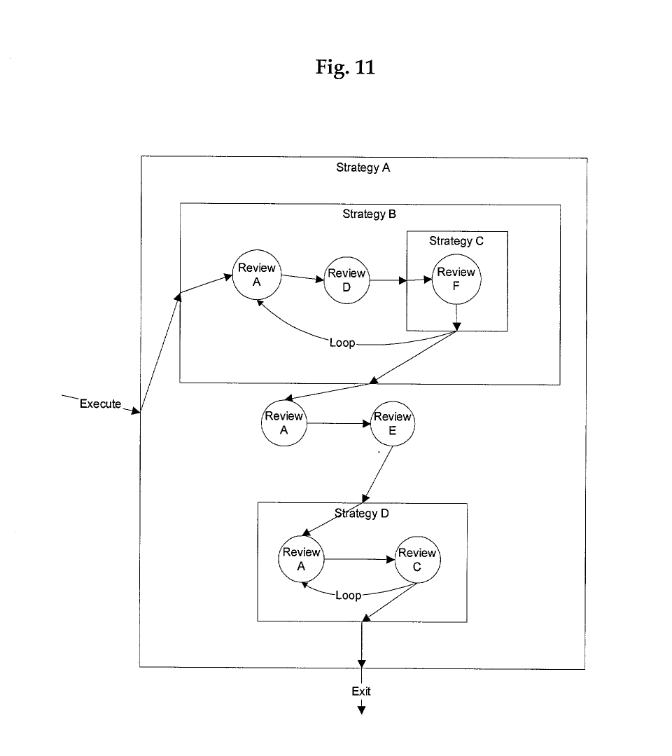

In the present invention, the procedure of FIG. 3 is not coded by programmers in a programming language, but instead is implemented in tables. This is possible because numerous procedures have the same basic structure of FIG. 3, involving Reviews which are analyzed or not based upon conditional statements. The Reviews also are often nothing more than accesses of attributes. FIG. 4 shows the Strategy of FIG. 3 implemented in a table as strategy “S1.” As seen in the chart, there are three elements in this strategy, namely Reviews one, two and three. These three reviews are processed in this order, as shown by the evaluation order column. The last column indicates the conditional expression that will determine whether the particular review will be evaluated. There is no conditional for Review one, indicating that this review will always be analyzed in strategy S1. Note that strategy S2 is also defined in this chart. S2 evaluates Review one if Conditional Three is true, and will always execute Review four.

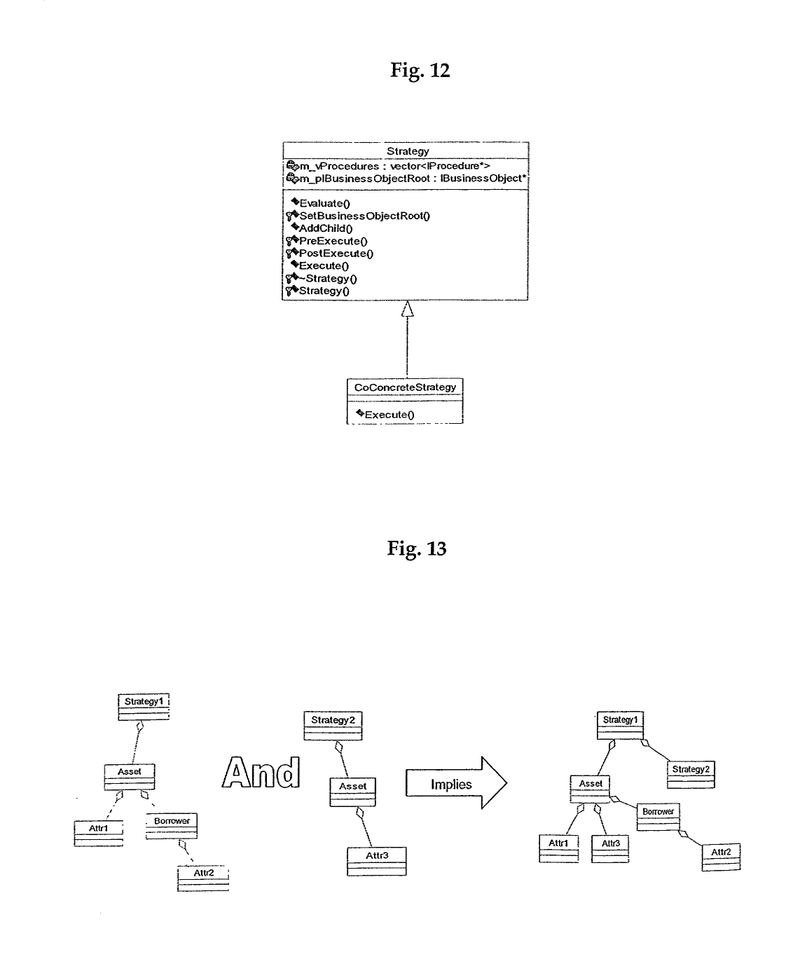

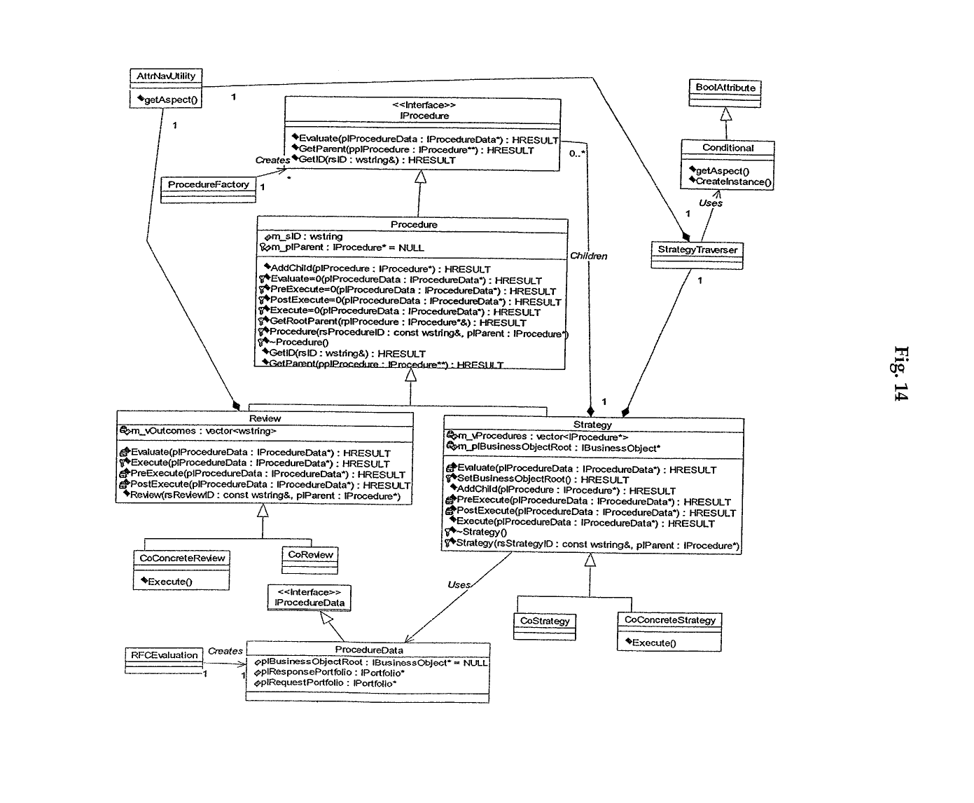

FIG. 5 contains a chart of conditional statements. Conditional one contains two rows, indicating that the conditional contains two expressions joined by the logical operator AND, as indicated by the last column. The recalculate column indicates whether or not the attributes in the conditional expression should be recalculated every time they are accessed, or whether a prior calculation for an attribute value should be accepted.

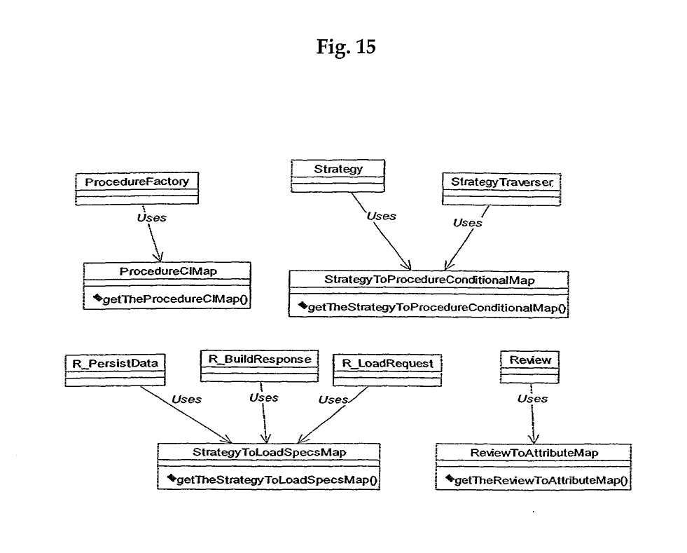

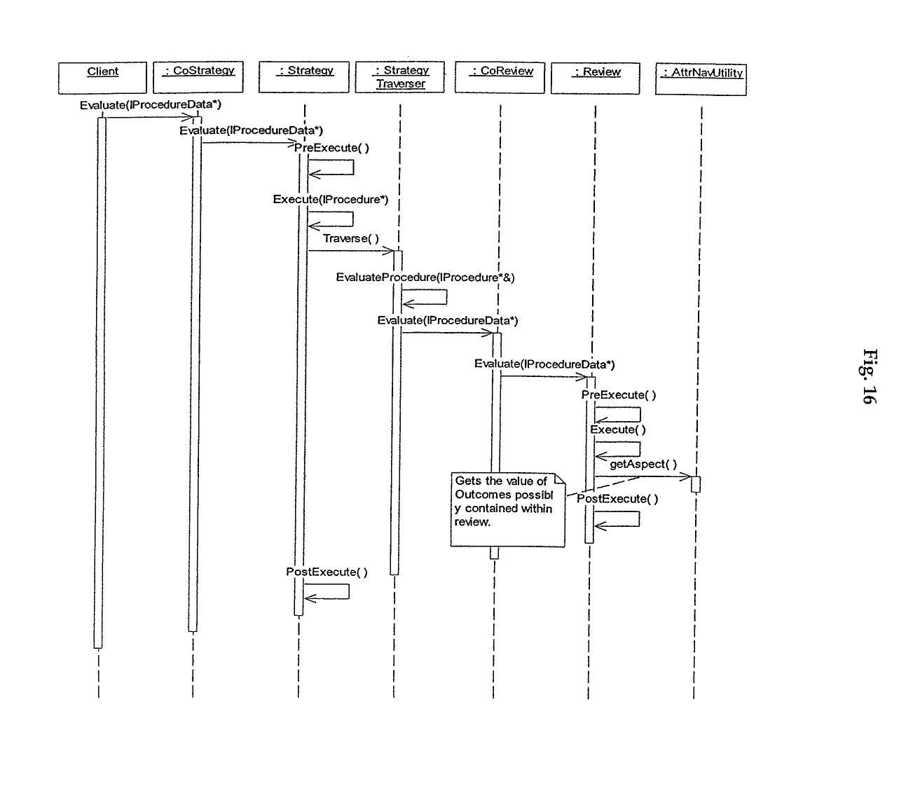

FIG. 6 implements the reviews in a table. Note that reviews can only be implemented in a chart if their function is to simply access attribute values. While this is true of a great many of the Reviews actually implemented in real world situations, it is often necessary to have some reviews programmed by programmers to accomplish more sophisticated functionality. These types of reviews would not be implemented in the table of FIG. 6.

In FIG. 6, Reviews one, two and three are all implemented in the table. Reviews one and three simply request the value for a single attribute, namely attribute Al. Review two requests the value for two attributes, namely attribute A2 and A3. The order in which these attribute requests are made is shown in the second column.

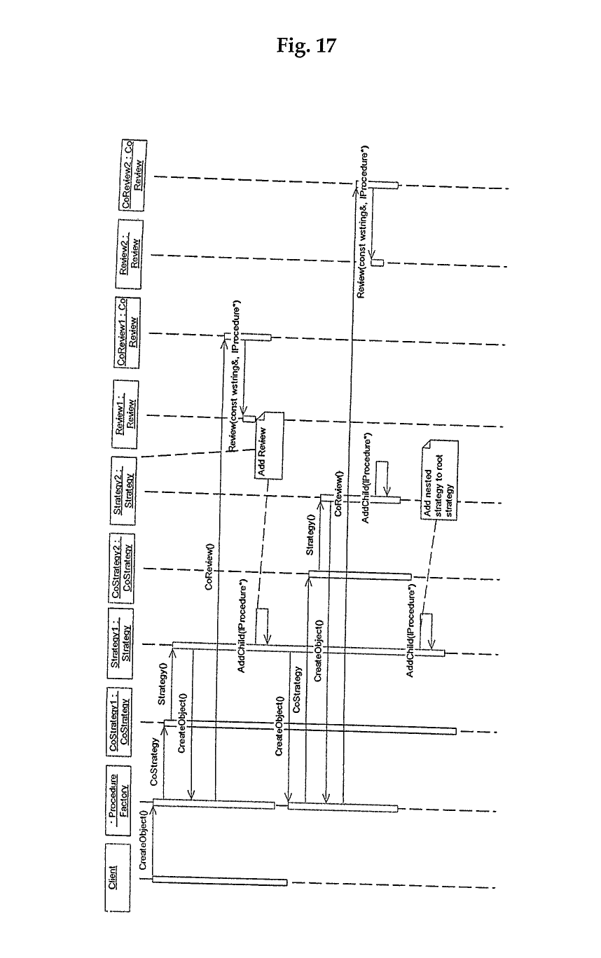

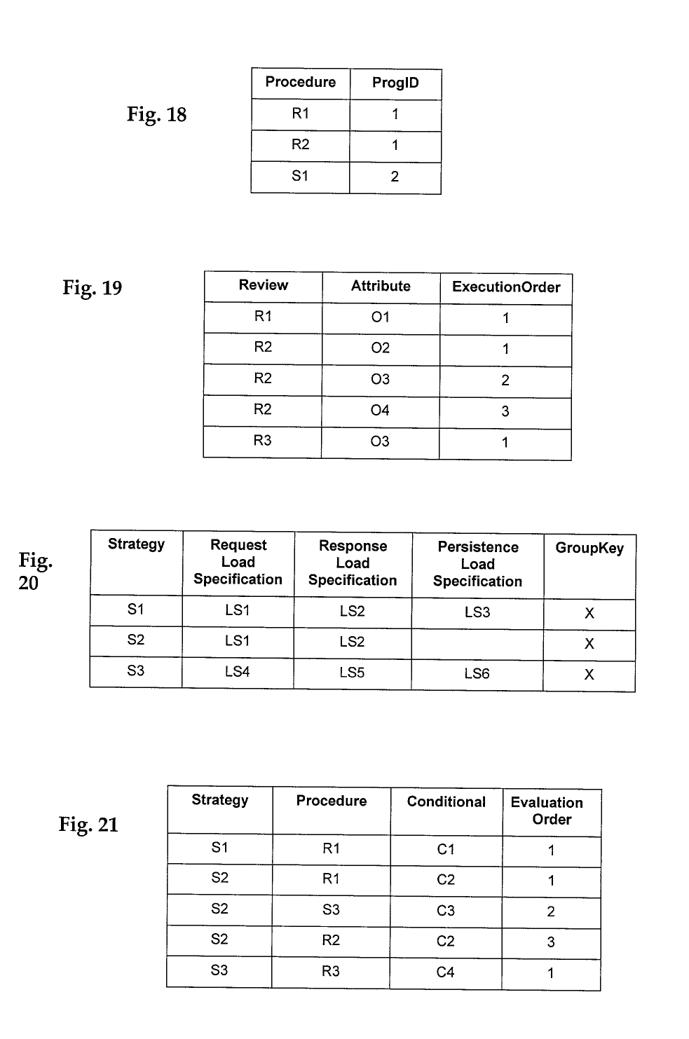

In the present environment, it is possible for a strategy to access another strategy as well as a review. This is shown in strategy S3 shown in FIG. 7. Like strategies Si and S2, strategy S3 starts by calling a review, namely Review two. This call to Review two is always done, without any conditional statement being evaluated first. The next step in S3, as determined by the evaluation order column, is a call to strategy S2. This call is conditioned upon the successful evaluation of Conditional two.

In order to allow a loop to occur within this simple framework of table defined strategies, a conditional call to a strategy is always considered a potential loop. Thus, when strategy S2 is completed, conditional two will be reevaluated. If conditional two is still true, then strategy S2 is evaluated again. This loop will continue as long as conditional two evaluates to true, so S2 must eventually alter the result of conditional two to avoid an endless loop.

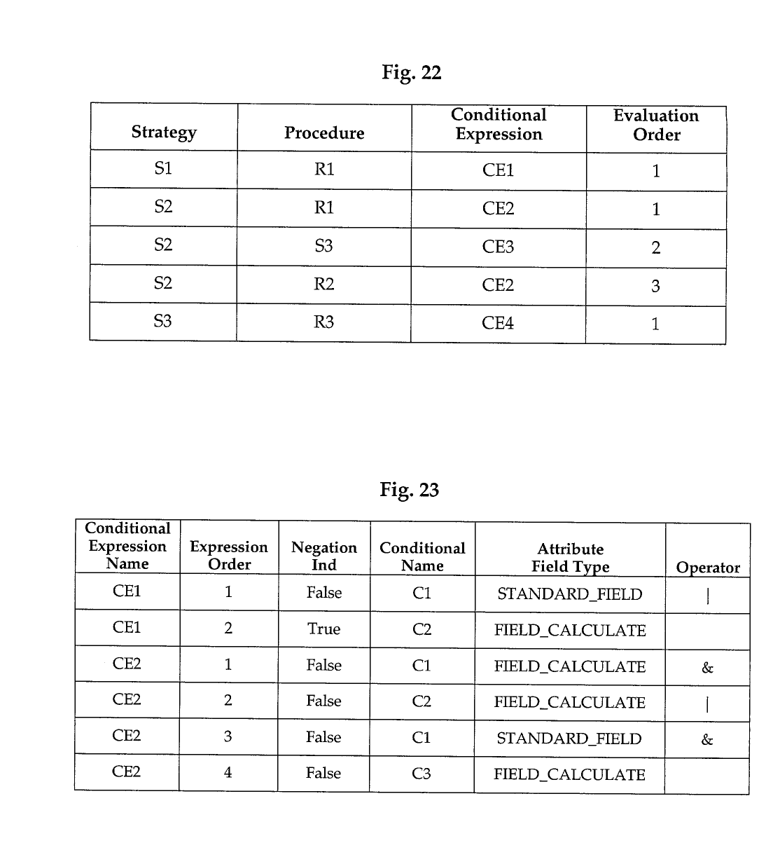

Strategy S3 containing a conditional loop of strategy S2 is shown in the block diagram of FIG. 8. When S3 is initiated, Review two is always executed. After Review two, conditional two is evaluated. If it is false, strategy S3 is complete. If conditional two is true, then strategy S2 is evaluated. As explained above, strategy S2 is defined as two Reviews, namely Review one and two. The evaluation of Review one in strategy S2 is conditioned on conditional three. After strategy S2 is evaluated, conditional two is again evaluated to see if the looping of strategy S2 should continue.

A detailed description of an implementation of the present invention is set forth in the Appendix, which forms an integral part of the specification of the invention.

Of course, many possible combinations of features and elements are possible within the scope of the present invention. For instance, although the strategies, reviews, and conditionals are described as being embodied in tables, any simple database construct could perform equally well and hence would be covered by the present invention. Further, because conditional statements can be converted between true and false, any reference to a specific result of a conditional statement is identical to the exact opposite result. Consequently, there should be no distinction made between whether the language of this application indicates a conditional is determined to be true versus false. Because many such combinations are present, the scope of the present invention is not to be limited to the above description, but rather is to be limited only by the following claims.

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for implementing calls to an implementation of business logic comprising:
a) defining a procedure as an entry in a database having at least one call to a review;
b) defining a review as an entry in a database having at least one request to determine a value for an attribute; and
c) determining the value for the attribute by initiating the evaluation of business rules when a request for the value for the attribute is received.

2. The method of claim 1, wherein the call to the review is conditional upon an evaluation of a conditional statement.

3. The method of claim 2, wherein the entry for the procedure further includes at least one call to another procedure.

4. The method of claim 3, wherein the call to another procedure is conditional upon the evaluation of a second conditional statement.

5. The method of claim 4, wherein the call to another procedure is a loop that reevaluates the procedure until the second conditional statement is evaluated differently.
